(19) United States
(12) Patent Application Publication
(10) Pub. No.: US 2021/0023689 A1
(43) Pub. Date: Jan. 28, 2021

(54) ROUTING ADAPTER FOR WIDE SHALLOW RECESSES

(71) Applicant: Augustine Albert Iocco, Harrison City, PA (US)

(72) Inventor: Augustine Albert Iocco, Harrison City, PA (US)

(21) Appl. No.: 16/510,898

(22) Filed: Jul. 13, 2019

(51) Int. Cl. B25F 3/00; B27C 5/10

(52) U.S. Cl. CPC B25F 3/00; B27C 5/10

(57) ABSTRACT

A router apparatus for cutting grooves in surfaces at a range of depths includes a housing having a central threaded aperture, a set of saw blades with a diameter less than the aperture. In addition, the apparatus includes at least one handle attached to a side of the housing, an adjustment bushing configured for operational engagement with the central threaded aperture, wherein turning the bushing adjusts the cutting depth of the set of saw blades, and a female coupling opposite the set of cutting blades wherein the female threads are operationally engageable with the male threads of a common right-angle grinder.

### FIELD OF THE INVENTION

The present invention relates in general to a router adapter housing and more particularly, this invention relates to a router adapter housing that connects a wide router saw with a right-angle grinder.

### BACKGROUND OF THE INVENTION

1. Woodworking machines, such as routers, which support a vertical rotating spindle that carries a cutting tool for the purpose of forming grooves in lumber are well known; however, conventional routing and similar woodworking machines normally are restricted to one unit. Plunge type routers offer cutting depth adjustment, but over a rather narrow range of cutting diameters for the bits. They all have an integral motor built in. In U.S. Pat. No. 4,913,204, a biscuit planar-jointer is disclosed by Moores et al with an integral drive motor with a drive shaft at a 90-degree angle to the plane of a cutting blade. Prior Art also discloses a typical one piece electric router under patent number U.S. Pat. No. 1,109,755. Another exemplary type of router disclosed by Prientka is show in U.S. Pat. No. 6,726,414. Willets, in British Patent GB 2,350, 084, discloses an adaptor for making a right-angle grinder motor into either a router or biscuit planar-jointer. In many respects, the woodworking apparatus according to the present invention substantially departs from the conventional concepts and designs of the prior art, particularly with respect to cutting width and depth adjustment.

### SUMMARY OF THE INVENTION

The present invention provides a cost-effective way of attaching a router adapter housing to a standard right angle grinder by way of a threaded coupling. It includes a truncated pyramid housing having a threaded central aperture configured to accommodate an adjustment nut mating with the threaded central aperture and an arbor. A cutting blade is removably fastened to the arbor from the wider underside of the truncated pyramid housing. At least one handle is removably attached to the housing.

### OBJECTS OF THE INVENTION

It is therefore one of the primary objects of the present invention is to provide the means of combining the desirable convenience of turning a right angle grinder into a router.

Another object of the present invention is to provide an attachment for a right angle grinder capable of cut width at least three times what typical routers can do.

Still another object of the present invention is to have an adjustable cutting dept with a range of 0″ to ⅜″ of an inch for the purpose of cutting wide grooves or recesses in lumber.

Still another object of the present invention is to have replaceable blades that are attached by a five bolt pattern arbor.

An additional object of the present invention is to protect the hands and fingers from possible danger with a large shroud on the handles.

Still additional object of the present invention is to have the ability to attach directly to a right angle grinders ⅝″×11 male threaded shaft.

Yet another object of the present invention is to have a base plate that will act as a guide when routing through lumber.

In addition to the various objects and advantages of the present invention described with some degree of specificity above, it should be obvious that additional objects and advantages of the present invention will become more readily apparent to those persons who are skilled in the relevant art from the following more detailed descriptions of the invention, particularly, when such description is taken in conjunction with the attached drawings figures and with the appended claims.

### BRIEF DESCRIPTION OF THE DRAWINGS

FIG. 1 provides a bottom perspective view of the router housing of the invention.

FIG. 2 illustrates a detailed exploded isometric view of the present invention with parts shown.

FIG. 3 provides a top perspective view showing the saw blades.

### DETAILED DESCRIPTION OF A PRESENTLY PREFERRED AND VARIOUS ALTERNATIVE EMBODIMENTS OF THE INVENTION

Prior to proceeding to the more detailed description of the present invention, it should be noted that, for the sake of clarity and understanding, identical reference numerals throughout the several views illustrated in the figures.

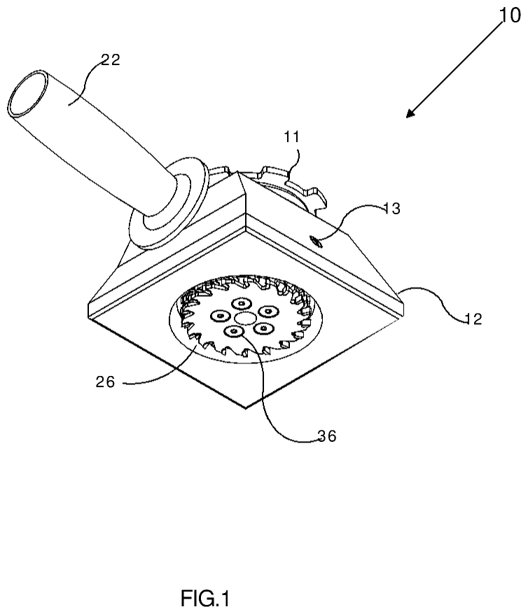

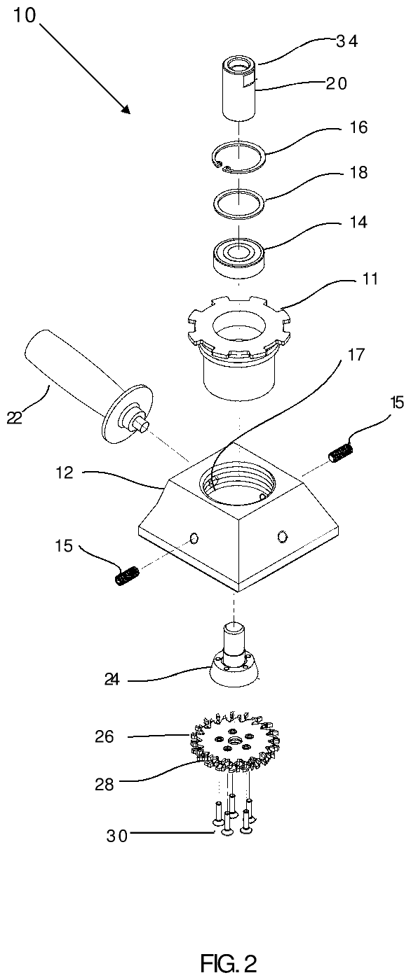

Referring initially to FIG. 1, this provides a bottom perspective view of the present invention, generally shown as 10. An aluminum base plate 12, which has a threaded aperture 13, interfaces with a cylindrical aluminum depth adjusting bushing 11. The adjuster may be locked in place by two set screws (15 on FIG. 2) housed in the body of the base plate 12. The adjusting nut 11 can be unlocked to permit the blades 26 to be lowered such as to allow the router to cut a wide groove, typically 4 to 8 cm across, the exact depth desired to permit a wide planar plate to be installed so as to be flush with the underside of a countertop for reinforcing an overhang.

FIG. 2 provides a perspective exploded isometric view of a preferred embodiment of the present router housing invention (Brace Setter generally shown as 10.) An aluminum base plate 12 has a central threaded aperture 17, which interfaces with a cylindrical aluminum cutting depth adjuster 11. The adjuster is locked in place by two set screws 15 housed in the body of the base plate 12. An arbor 24 fitting up through the center of the bushing, has a five bolt circle 36 section for anchoring three saw blades 26. Between the three saw blades are two spacers 28. There is a snap ring retainer clip 16 that applies pressure against a spring wave washer 18 that holds bearing 14 in place. The arbor 24 is passed through bearing 14, then threaded onto coupling 20, which also has a flat spot 34 for supporting a wrench.

At the bottom of the arbor is a five bolt circle 36 section for anchoring a three saw blade layers 26 between the three saw blades are two spacers 28. The saw blades are secured into place by way of five number 8×32 screws 30. A safety handle 22, with a large shroud to protect the hands and fingers, allows the user to firmly grasp the tool. There is also an optional second support handle location 32.

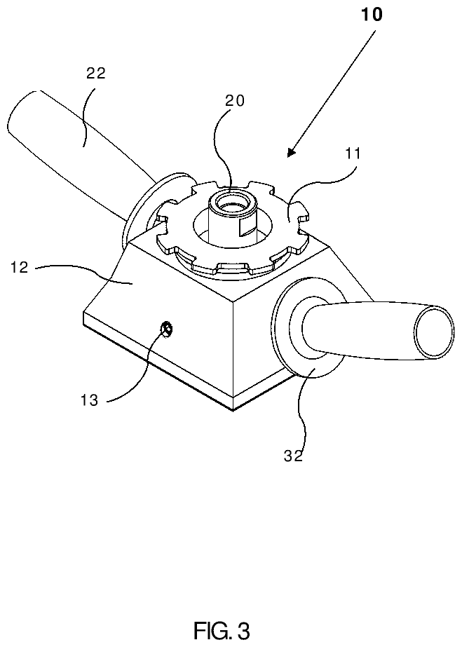

FIG. 3 provides a top perspective view of the present invention 10, showing the handle 22 with a shroud 32. There is an option to add a second handle 22. There is a coupling 20, which enables operably connecting to a right angle grinder by way of ⅝″×11 threads. It can easily be transformed into a precision wood router having an adjustable routing depth with a range of 0 to ⅜ of an inch deep (1 cm) for the purpose of cutting recesses or grooves in building materials such as lumber. The cutting depth adjuster 11 allows for the adjustable cutting depth over a limited range.

What is claimed is:

1. A router apparatus for cutting grooves in surfaces at a range of depths, the router apparatus comprising:
a) A base housing having a central threaded aperture with a first predetermined diameter;
b) a set of saw blades with a second predetermined diameter, wherein said second predetermined diameter is less than said first predetermined diameter;
c) at least one handle attached to a side of said base housing;
d) an adjustment bushing configured for operational engagement within said central threaded aperture, wherein turning the bushing adjusts the cutting depth of said set of saw blades within a preselected range; and
e) a female coupling opposite said set of cutting blades wherein said female threads are operationally engageable with the male threads of a common right-angle grinder.

2. The router apparatus of claim 1 wherein said set of saw blades is three.

3. The router apparatus of claim 1 wherein said preselected depth range is zero to one centimeter.

4. The router apparatus of claim 1 wherein said depth adjustment bushing can be locked in place temporarily with at least one set screw.

5. The router apparatus of claim 2 wherein said second predetermined diameter is between 4 and 8 centimeters.

6. A groove-cutting adapter for a right-angle grinder comprising:
a) a base housing having a body with a planar lower surface and a central threaded aperture through the planar lower surface and an upper end wherein the aperture has a first predetermined diameter;
b) a saw blade with a second predetermined diameter, wherein the second predetermined diameter is less than said first predetermined diameter;
b) at least one handle attached to a side of said housing;
d) an adjustment bushing configured for operational engagement within the central threaded aperture, wherein turning the bushing adjusts the cutting depth of the saw blade within a preselected range; and
e) a female coupling operationally engageable with the cutting blade for rotation and wherein said female threads are operably connected with the male threads of a common right-angle grinder.

7. The groove-cutting adapter of claim 6 wherein wherein the preselected cutting depth range is zero to one centimeter.

8. The groove-cutting adapter of claim 6 wherein the second predetermined diameter is between 4 and 8 centimeters.

9. The groove-cutting adapter of claim 6 wherein at least one handle is attached to the base housing.

10. The groove-cutting adapter of claim 6 wherein the base is a truncated pyramid.

11. The groove-cutting adapter of claim 9 wherein at least one handle has protective shroud.
